(19) United States
(12) Patent Application Publication
(10) Pub. No.: US 2016/0314357 A1
(43) Pub. Date: Oct. 27, 2016

(54) Method and Device for Monitoring an External Dimension of a Vehicle

(71) Applicants: CONTI TEMIC MICROELECTRONIC GMBH, Nürnberg (DE); APPLICATION SOLUTIONS (ELECTRONICS AND VISION) LTD., Lewes (GB)

(72) Inventors: Wolfgang FEY, Bodolz (DE); Eric HANTSCH, Brighton (GB); Vaclav MOCEK, Seaford (GB); Gideon READE, Worthing (GB); Ian SAWARD, Lewes (GB); Ravikanth UPPARA, Seaford (GB); Dave WELLER, Lewes (GB)

(21) Appl. No.: 15/105,379

(22) PCT Filed: Oct. 28, 2014
(86) PCT No.: PCT/DE2014/200603

§ 371 Date: Jun. 16, 2016

(30) Foreign Application Priority Data
Dec. 16, 2013 (DE) 10 2013 226 104.7

(51) Int. Cl. G06K 9/00; H04N 5/232

(52) U.S. Cl. CPC G06K 9/00791; H04N 5/232

(57) ABSTRACT

The invention relates to a method and a device for monitoring an external dimension of a vehicle, particularly of a change in the external dimension due to an external vehicle load.

The invention relates to a method and a device for monitoring an external dimension of a vehicle, particularly with respect to a change in the external dimension of a vehicle due to an external vehicle load.

Optical sensor systems, particularly cameras for covering the surroundings of the vehicle, have been increasingly used in vehicles for several years. By means of special electronic devices and software, these systems can take on various functions that assist the driver, which is why such systems are also called assistance systems or driver assistance systems. Some of these assistance systems are already capable of performing autonomous or semi-autonomous driving maneuvers, e.g., performing maneuvers in order to get into and/or out of parking spaces.

For example, a system for assisting the driver when he or she gets into a parking space is known from DE 10 2009 057 837 A1. The system serves to assist the driver when he or she gets into a parking area of a vehicle garage. The surroundings of the vehicle are covered by means of a camera system. The images of the surroundings are analyzed by means of an image analysis method in order to detect the garage entrance of the vehicle garage. After the detection of the garage entrance, the image of the surroundings is analyzed, by means of a mark recognition method, for at least one mark arranged on a back wall of the garage. After that, the position of the vehicle relative to the garage entrance and the mark is determined and control signals indicating steering angles required for steering the vehicle into the parking area are generated depending on the determined position of the vehicle. The control signals may be indicated to the driver as steering advice or supplied to at least one control system in order to realize semi-automatic or fully automatic driving of the vehicle into the parking area.

For assistance systems for performing autonomous or semi-autonomous driving maneuvers, sensor systems capable of covering the complete surroundings of the vehicle (panoramic view (360°) around the vehicle) can be already used nowadays.

Concerning this, DE 10 2006 036 933 A1 shows a method for generating an overall image from at least two overlapping individual images, wherein cameras arranged on a motor vehicle acquire the individual images and an image processing device puts the individual images together so that the overall image is formed.

Systems as described in DE 10 2006 036 933 A1 are also referred to as top view systems or surround view systems. Surround view systems typically comprise several (real) image acquisition cameras arranged in or on the vehicle. Image data are generated from various regions of the surroundings of the vehicle by means of said image acquisition cameras and then subjected to different transformations in an electronic image data processing device and a complex image of the complete surroundings of the vehicle is generated, whereby, e.g., a view of the surroundings of the vehicle from a perspective above the vehicle roof (bird's eye view) can be obtained, i.e., the image is generated from the perspective of a virtual camera located above the vehicle. The overall image can be continually displayed to the driver of the motor vehicle on a display device in order to, e.g., make shunting or parking maneuvers easier. It is also possible to process/analyze the overall-image data by means of assistance systems for performing autonomous and semi-autonomous driving maneuvers, e.g., for object detection and for the derivation of control commands.

The process responsibility of assistance systems that serve to perform autonomous or semi-autonomous driving maneuvers is especially high. In particular, other road users must not be endangered and the ego-vehicle or other vehicles must not be damaged. This must be ensured at any time during an autonomous or semi-autonomous driving maneuver.

The external dimensions of the vehicle must be known at any time in order to be able to ensure the safety of and the practicability of autonomous/semi-autonomous driving maneuvers and, in principle, also of manually performed driving maneuvers. This particularly relates to the height, the length and the width of the vehicle. These dimensions may be changed due to vehicle loads, e.g., due to a load on a trailer, on a vehicle-tail loading area, on a roof rack, or on a tail rack.

The object of the present invention is to specify a method and a device that enable dimensions of a vehicle, particularly a possible change in the current external dimensions of a vehicle, to be monitored.

This object is achieved by a method with the features according to claim 1 and by a device with the features according to claim 10. Advantageous realizations and further developments are the subject matter of subclaims, wherein combinations and further developments of individual features are also possible.

An essential idea of the invention consists in monitoring at least one external dimension of a vehicle by means of at least one camera arranged on the vehicle, particularly in monitoring whether there is a change in at least one external dimension of the vehicle due to an external vehicle load (i.e., the fact that there is a change) and/or in determining the size of the dimension/the extent of change, wherein the camera may either directly cover a region of the vehicle in which an external vehicle load may be arranged and/or a region in which at least a shadow of an external vehicle load arranged on the vehicle may be detectable.

As mentioned in the introduction above, cameras are already arranged in many vehicles nowadays so that preferably one or more cameras already present in the vehicle may be used to implement the inventive method/for the inventive device. Within the scope of the invention, it is also possible to retrofit a vehicle with one or more cameras.

Image processing devices and methods that are capable of detecting (particularly by means of suitable image processing algorithms) vehicle loads and preferably the dimensions thereof in image data acquired by means of a camera are also known already.

The inventive method for monitoring at least one external dimension of a vehicle preferably comprises the following steps:
covering a region of the vehicle by means of at least one camera arranged on the vehicle;
processing image data with respect to an external vehicle load, said image data being generated by means of the at least one camera;
monitoring the at least one external dimension depending on the processing of the image data.

When monitoring the at least one external dimension of the vehicle, one preferably determines whether there is a change in the at least one external dimension of the vehicle due to an external vehicle load, wherein, in particular, one may determine whether a current external dimension of the vehicle is different from a previously determined size of the dimension and/or from an initial dimension (e.g., the basic dimension of the vehicle) due to the arrangement of an external vehicle load. One may also determine whether the current external dimension is larger or smaller than a previous dimension. Furthermore, the monitoring of the external dimension of the vehicle preferably includes the determination of the size of the external dimension/of the extent of change, i.e., of the size of the current/of the changed external dimension of the vehicle.

According to a preferred realization of the inventive method, the at least one camera covers a region of the vehicle in which an external vehicle load may be arranged and is thus detectable in image data acquired by means of the camera, wherein, for example, a tail region of the vehicle in which a vehicle load may be arranged on, e.g., a trailer, a vehicle-tail loading area or a tail rack (e.g., for baggage or bicycles) is covered by means of a backup camera/rear-view camera. Furthermore, a roof region of the vehicle in which a vehicle load may be arranged on, e.g., a roof rack may be covered by means of, e.g., a camera that is laterally arranged on the vehicle and suitably directed (e.g., by means of a camera for a mirror substitute system).

The processing of the image data preferably comprises the search for characteristic features of external vehicle loads in the image data if, in particular, a region of the vehicle in which an external vehicle load may be arranged and detectable is covered by means of the at least one camera, i.e., if a direct detection of the vehicle load is provided within the scope of the inventive method.

Alternatively or additionally, the processing of the image data may comprise the search, by means of an optical-flow method, for image segments in which there is motion.

According to a further preferred realization of the inventive method, a region of the vehicle and/or a region surrounding the vehicle in which at least a shadow of/a shadow cast by an external vehicle load may be detectable is covered by means of the at least one camera, wherein, for example, an external vehicle cover (e.g., the hood, the trunk lid, or a lateral vehicle cover) and/or a particular region of the surroundings of the vehicle (e.g., the road surface/pavement) may be covered by means of the at least one camera.

The processing of the image data preferably comprises the search for a shadow of/for a shadow cast by an external vehicle load if, in particular, a region of the vehicle and/or a region surrounding the vehicle in which a shadow of an external vehicle load may be detectable is covered by means of the at least one camera, i.e., if an indirect detection of the vehicle load is provided within the scope of the inventive method.

Thus, the monitoring of the at least one external dimension of the vehicle may be performed, according to the invention, both by a direct detection of an external vehicle load by means of the at least one camera and by an indirect detection, i.e., by detecting a shadow of/a shadow cast by an external vehicle load, wherein the method is not limited to the exclusive use of direct detection or of indirect detection, but may also use a combination of both techniques.

Within the scope of the inventive method, the monitoring of the at least one external dimension, particularly the determination of the size thereof, is preferably performed depending on a known installation position and/or orientation of the at least one camera, wherein, particularly in the case of a detection of an arrangement of an external vehicle load on the vehicle, it is possible, depending on the installation position and the orientation of the camera, to determine the dimensions of the vehicle load from the image data and determine the at least one external dimension of the vehicle/the change therein from said dimensions.

The inventive device for monitoring at least one external dimension of a vehicle comprises at least one camera that is arranged on the vehicle and acquires image data from a region of the vehicle and/or from a region surrounding the vehicle. The device also comprises means for processing the image data with respect to an external vehicle dimension, said image data being acquired by means of the at least one camera, and means for determining the at least one external vehicle dimension depending on the processing of the image data.

At the same time, the inventive device is preferably designed to implement a method according to one of the realizations described above.

Further advantages and possible applications of the present invention can be inferred from the following description taken in conjunction with the exemplary embodiment illustrated in the drawing.

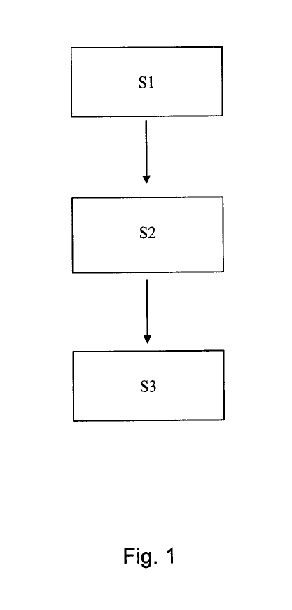

FIG. 1 shows a flow chart of an exemplary embodiment of the inventive method for the camera-based monitoring of at least one external dimension of a vehicle.

The invention provides that a region of the vehicle in which an external vehicle load may be arranged and/or in which at least a shadow of such a load may be detectable is covered/monitored by means of at least one camera (step S1 in FIG. 1).

In particular, the region of the vehicle may also be a region surrounding the vehicle, wherein the camera may be mounted, e.g., in the passenger compartment of the vehicle or outside the vehicle and directed toward the corresponding region in order to generate image data of the corresponding region. In particular, the at least one camera may be at least one driver assistance system camera already present in the vehicle, e.g., one or more cameras of a surround view system. Furthermore, it is also possible to process the overall image of a surround view system within the scope of the inventive method. It is, in principle, sufficient to cover a region in which the vehicle load/the shadow thereof is at least partially located/detectable. It is, of course, also possible to cover a region that is large enough to enable the complete vehicle load to be detected. Furthermore, the covered region may be selected such that the surroundings of the vehicle are at least partially covered in the absence of any vehicle loads arranged on the vehicle, particularly in order to be able to detect motions in the images acquired by means of the camera.

The invention also provides that the image data generated by the at least one camera are processed with respect to an external vehicle load (step S2 in FIG. 1).

Concerning this, the processing of the image data, particularly with respect to an external vehicle load in the image data acquired by means of the at least one camera, may comprise, according to the invention, the search for characteristic features of external vehicle loads, if, in particular, a region of the vehicle is covered by means of the camera so that vehicle loads may be directly detectable in the image data. In particular, so-called pattern recognition methods/template matching methods, which are principally known from the prior art and in which a search for, e.g., contours of an external vehicle load in the image data is performed, may be used for this purpose.

Furthermore, the detection of a vehicle load may be based on a recognition of characteristic vehicle load structures, e.g., of particular typical structures such as straight, oblong elements of rack struts or of rack rods.

Furthermore, the currently acquired image data may be compared with stored image data acquired by the camera at a time when no vehicle load was arranged on the vehicle, wherein, in particular, such a comparison of the image data may be performed continually.

It is also possible to use a classifier that was trained by means of images of a plurality of vehicle loads or varieties thereof. By means of said training, the classifier finds and “learns” characteristic features of vehicle loads and stores these features for the purpose of classification.

Furthermore, the processing of the image data may include a search for image segments in which there is motion. This may be performed by means of a so-called optical-flow method. The existence of motion in an image segment implies that this image segment is not covered by a component that is firmly connected to the vehicle, wherein, for the purpose of detecting a vehicle load, the image may be subdivided into a number of sections. For each section, data as to whether a motion was detected in this section or not may be acquired. In this manner, another image may be generated, said image showing the intensity of motion, not the brightness. This image may then be used for the actual detection of an external vehicle load. For this purpose, sections in which there is no motion may be detected in the intensity-of-motion images, and the detected sections in which there is no motion may be classified with respect to characteristic features of the corresponding vehicle region with or without a load.

The image data generated by the camera may also be processed with respect to characteristic features of an external vehicle load in the image data if a region of the vehicle in which a shadow of an external vehicle load may be detectable is covered by means of the camera, e.g., due to an arrangement and an orientation of the camera that enable the camera to at least partially cover a region of the pavement or an external vehicle cover.

Concerning this, the processing of the image data, particularly with respect to an external vehicle load, preferably comprises the search for a shadow of/for a shadow cast by an external vehicle load, i.e., a shadow cast, e.g., on the pavement and/or on an external vehicle cover.

One or more of the above-described direct-detection methods, i.e., image processing methods for the recognition of patterns, structures and contours as well as suitable classifiers or optical-flow methods, may be equally used to search for a shadow/for a cast shadow.

The invention also provides that the at least one external dimension of the vehicle is monitored depending on the processing of the image data (step S3 in FIG. 1), wherein the at least one external dimension of the vehicle may be, e.g., the current and/or the maximum height, width or length of the vehicle/the change in these dimensions.

In the simplest case, the monitoring of the at least one external dimension of the vehicle may be a determination as to whether there is a change in the external dimension or not, wherein, depending on the processing of the image data, particularly if an arrangement of an external vehicle load on the vehicle was detected during said processing, a piece of information on the presence of a change in the external dimensions of the vehicle may be generated and made available, e.g., to the driver or to another system. Furthermore, a piece of information as to whether there is a change in the height, the length and/or the width of the vehicle may be generated.

Furthermore, the monitoring of the at least one external dimension may include a determination of the size of the corresponding dimension, i.e., the determination of the size of the new/of the current dimension, wherein, e.g., the maximum width, length or height of the vehicle may be calculated and/or it is possible to determine the corresponding dimensions with reference to one or more particular regions of the vehicle, e.g., with reference to the front axletree and the rear axletree. Furthermore, the corresponding dimensions may be determined with reference to a vehicle-related coordinate system, wherein, in particular, a detailed three-dimensional model of the vehicle may be generated, e.g., created in the form of an occupancy grid or of a height profile, of a width profile and/or of a length profile of the vehicle along the respective axis of a vehicle-related coordinate system.

In particular, the preferably continually determined dimensions of the vehicle may be used for/made available to one or more driver assistance systems (e.g., systems for performing autonomous or semi-autonomous driving maneuvers), particularly in order to be able to calculate trajectories and ensure the safety of the performance of these driving maneuvers.

Within the scope of the invention, the monitoring and the determination of the size of the at least one external dimension of the vehicle are preferably performed depending on known installation positions and orientations of the one or more cameras that is/are used within the scope of the method.

Furthermore, additional information (e.g., location, date, time of day, position of the sun, orientation of the vehicle, particularly a roll angle, pitch angle, yaw angle and roll angle of the vehicle) may be taken into account for determination when monitoring the external dimensions of the vehicle depending on a search for a shadow of/for a shadow cast by the vehicle/vehicle loads.

The above-described method may be implemented as a computer program that is executed by a computer that executes the steps of the method shown in FIG. 1. The image data acquired by means of the at least one camera are inputted into the computer for the purpose of further processing by means of the method. The computer may be implemented by a control device of a vehicle or of a driver assistance system. The inventive method may also be implemented as a part of a driver assistance software. In practice, the course of the method shown in the form of a flow chart in FIG. 1 may be executed cyclically or periodically or only once or twice during a journey.

### REFERENCE NUMERALS

S1 (step 1) covering a region of the vehicle by means of at least one camera arranged on the vehicle
S2 (step 2) processing image data with respect to an external vehicle load, said image data being generated by means of the at least one camera
S3 (step 3) determining the at least one external dimension depending on the processing of the image data.

1. A method of monitoring an external dimension of a vehicle, comprising steps:
with at least one camera arranged on the vehicle, imaging a region of the vehicle and producing image data,
processing the image data with respect to an external vehicle load, and,
monitoring the external dimension of the vehicle depending on the processing of the image data.

2. The method according to claim 1, wherein the monitoring of the external dimension comprises determining whether there is a change in the external dimension of the vehicle.

3. The method according to claim 1, wherein the monitoring of the external dimension comprises determining a size of the external dimension.

4. The method according to claim 1, wherein the at least one camera covers the region of the vehicle in which the external vehicle load may be arranged.

5. The method according to claim 1, wherein the processing of the image data comprises searching for characteristic features of external vehicle loads in the image data.

6. The method according to claim 1, wherein the processing of the image data comprises searching by an optical-flow method, for image segments in the image data in which there is motion.

7. The method according to claim 1, wherein the at least one camera covers the region of the vehicle and/or a region surrounding the vehicle in which a shadow of the external vehicle load may be detectable.

8. The method according to claim 1, wherein the processing of the image data comprises searching for a shadow of the external vehicle load.

9. The method according to claim 1, wherein the monitoring of the external dimension is performed depending on a known installation position and orientation of the at least one camera.

10. A device for monitoring an external dimension of a vehicle, comprising
at least one camera that is arranged on the vehicle and configured to acquire image data from a region of the vehicle,
first means for processing the image data with respect to an external vehicle load, and
second means for monitoring the external vehicle dimension depending on the processing of the image data.

11-12. (canceled)
